(19) United States
(12) Patent Application Publication
(10) Pub. No.: US 2015/0033614 A1
(43) Pub. Date: Feb. 5, 2015

(54) Rat Trap Wheel Chock

(71) Applicant: James Allen Allbright, JR., Woodridge, IL (US)

(72) Inventor: James Allen Allbright, JR., Woodridge, IL (US)

(21) Appl. No.: 14/048,110

(22) Filed: Oct. 8, 2013

Related U.S. Application Data
(60) Provisional application No. 61/860,499, filed on Jul. 31, 2013.

(51) Int. Cl. A01M 23/16; B60T 3/00

(52) U.S. Cl. CPC A01M 23/16; B60T 3/00
USPC 43/60; 188/32

(57) ABSTRACT

A rat trap wheel chock integrates a trap in the body of a wheel chock for capturing rats and other rodents. The wheel chock has at least one wheel bracing face and one ancillary face, with the wheel bracing face being designed to block a wheel (such as from an aircraft) from moving while the ancillary face provides an entrance to the interior of the wheel chock. The wheel chock has a chamber inside that forms part of the trap. Animals are capable of entering the trap through a one way entrance door placed in a lateral opening which is cut from the ancillary surface. The door is longer/taller than the door frame, which prevents the door from opening away from the chamber. A bottom surface has a bottom opening and sealing access door, which can be opened to dispose of captured animals.

The current application claims a priority to the U.S. Provisional Patent application Ser. No. 61/860,499 filed on Jul. 31, 2013.

### FIELD OF THE INVENTION

The present invention relates generally to a rat trap and a wheel chock combination. More specifically, the present invention is a rat trap wheel chock used to prevent rats from climbing up the landing gear of aircrafts for general aviation and airlines. The present invention prevents rats from chewing through wires and leaving behind corrosive feces and urine.

### BACKGROUND OF THE INVENTION

When aircraft are parked the potential for vermin to have access to an aircraft's landing gears increases significantly. These vermin either chew through wiring or corrode the area. It is therefore an object of the present invention to provide a rat trap built into a wheel chock for trapping harmful vermin. The purpose of the present invention is to prevent rats from climbing up the landing gear of aircraft, whether in general aviation or commercial airlines, and chewing through wires and leaving behind corrosive feces and urine which causes thousands of dollars damage in general aviation aircraft and tens of thousand dollars damage in airline aircraft. The present invention could also be used for vehicles and heavy equipment stored outside in the automotive department. The following is a description of the product and it is assumed that every time the word rat(s) is mentioned, a mouse, rat, or similar sized rodents is inclusive.

### BRIEF DESCRIPTION OF THE DRAWINGS

FIG. 1A is a perspective view of the present invention.

FIG. 1B is a perspective view showing the internal animal trap of the present invention.

FIG. 2 is a front view of the present invention.

FIG. 3 is a right-side internal view of the present invention.

FIG. 4 is a top view of the present invention.

FIG. 5 is a bottom view of the present invention.

FIG. 6 is a perspective view of the present invention showing the entrance door and access door in an opened position.

FIG. 7 is a front view of the present invention showing the entrance door and access door in an opened position.

FIG. 8 is a right-side internal view of the present invention showing the entrance door and access door in an opened position.

FIG. 9 is a top view of the present invention showing the entrance door and access door in an opened position.

FIG. 10 is a bottom view of the present invention showing the entrance door and access door in an opened position.

FIG. 11 is a right-side internal view of an alternative embodiment of the present invention with two entrance doors.

### DETAIL DESCRIPTIONS OF THE INVENTION

All illustrations of the drawings are for the purpose of describing selected versions of the present invention and are not intended to limit the scope of the present invention.

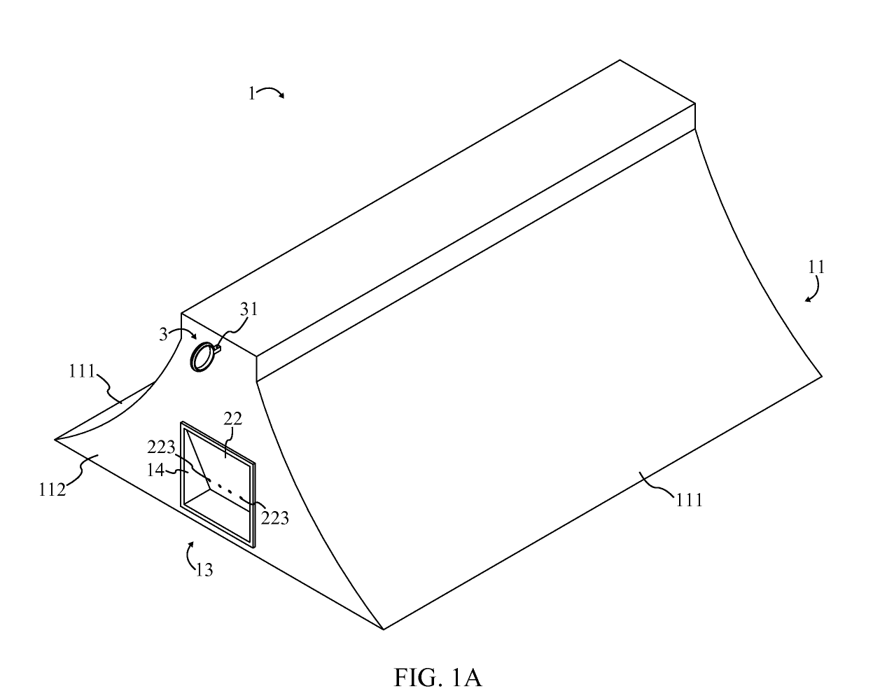

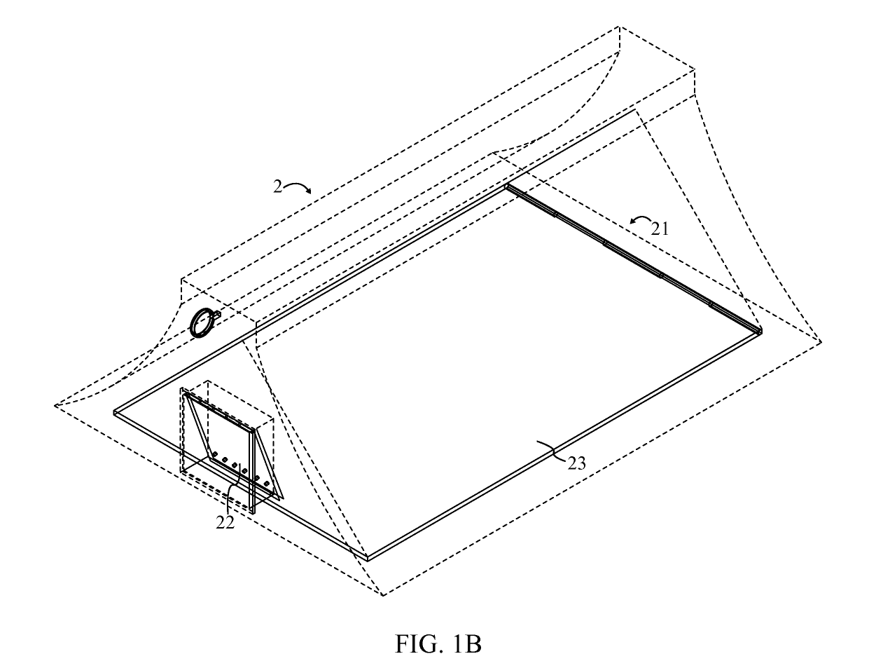

The present invention is a wheel chock 1 with an integrated animal trap. The present invention is designed to provide the functionality of a wheel chock 1 while preventing animals from accessing and damaging the wheel and suspension systems of vehicles. The present invention comprises a wheel chock 1 (FIG. 1A) and an animal trap 2 (FIG. 1B), with the animal trap 2 being built into the wheel chock 1. The animal trap 2 captures animals and prevents them from climbing up the wheels (e.g. the landing gear of an aircraft) that are held in place by the wheel chock 1. Protecting the landing gear and similar wheel systems is important as rodents can damage said systems by chewing through wires, nesting, and creating a buildup of urine and feces, all of which ultimately result in electrical problems and corrosion.

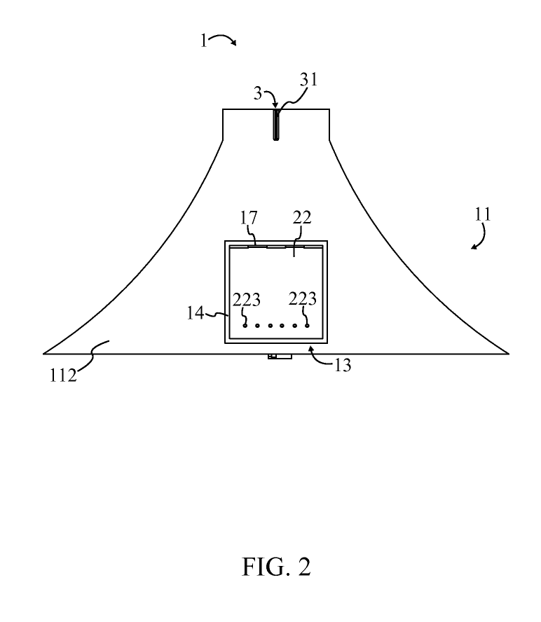

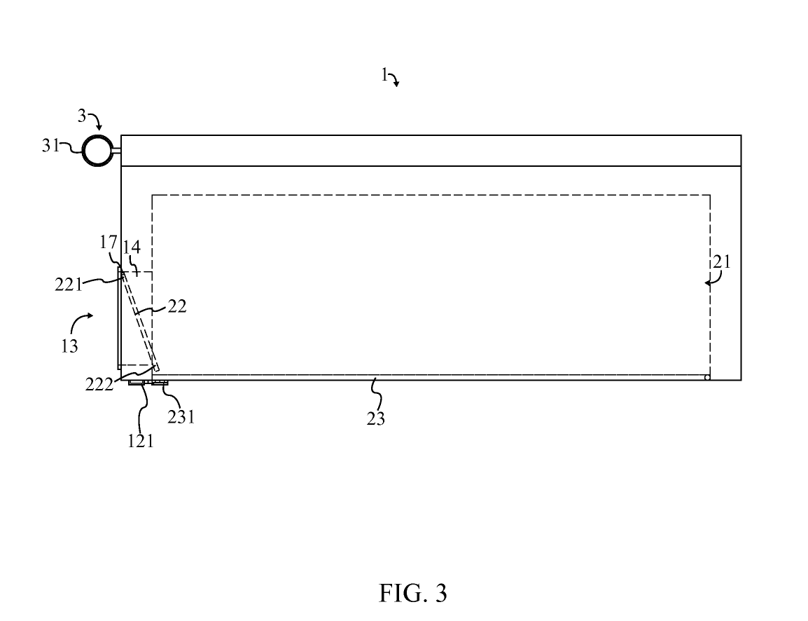

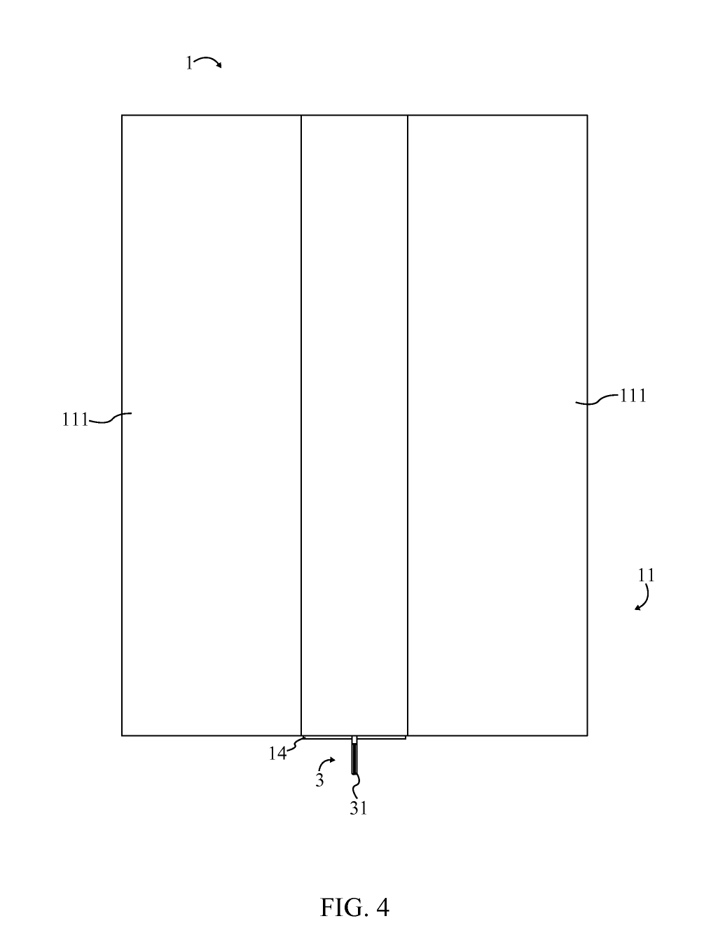

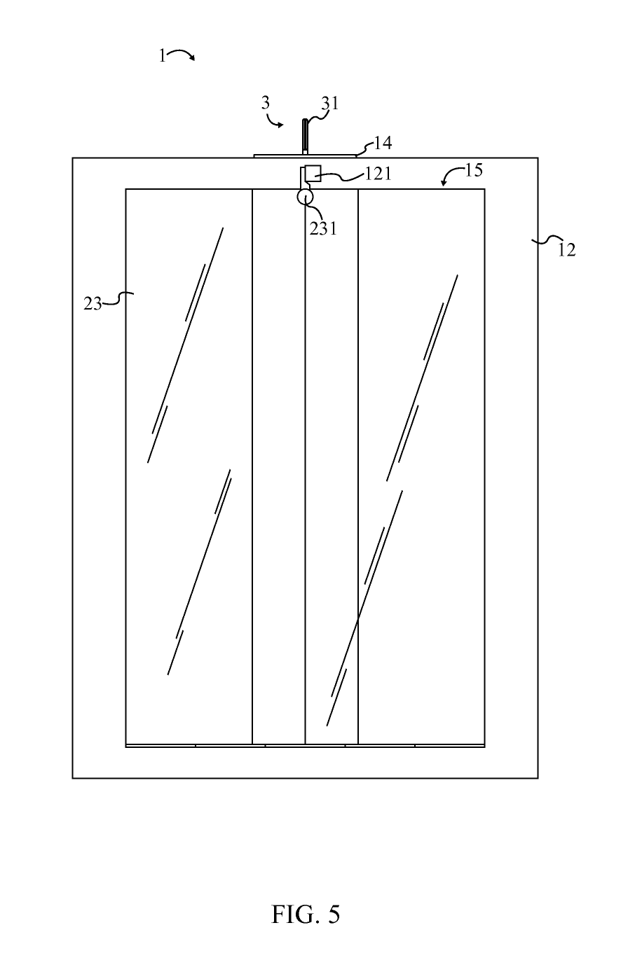

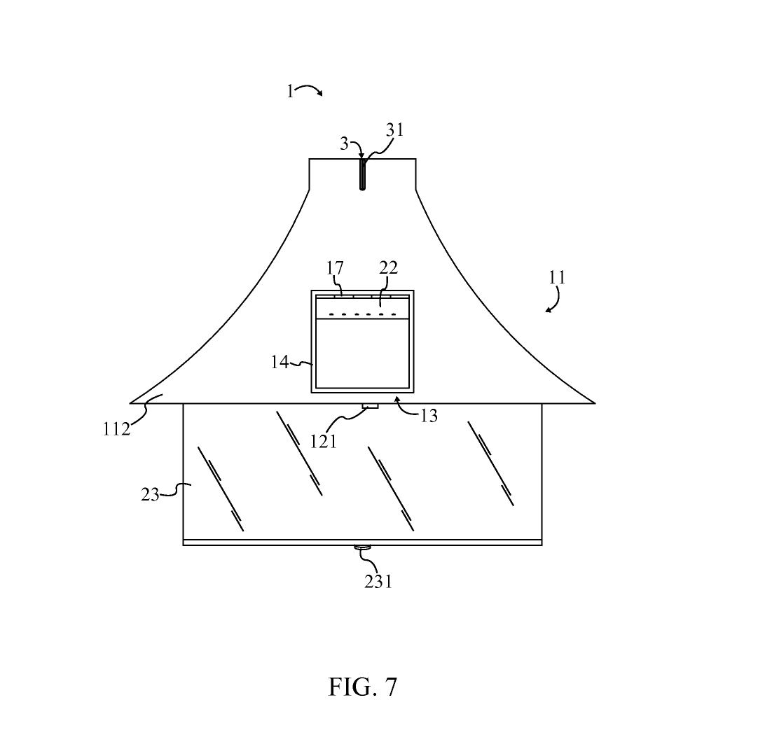

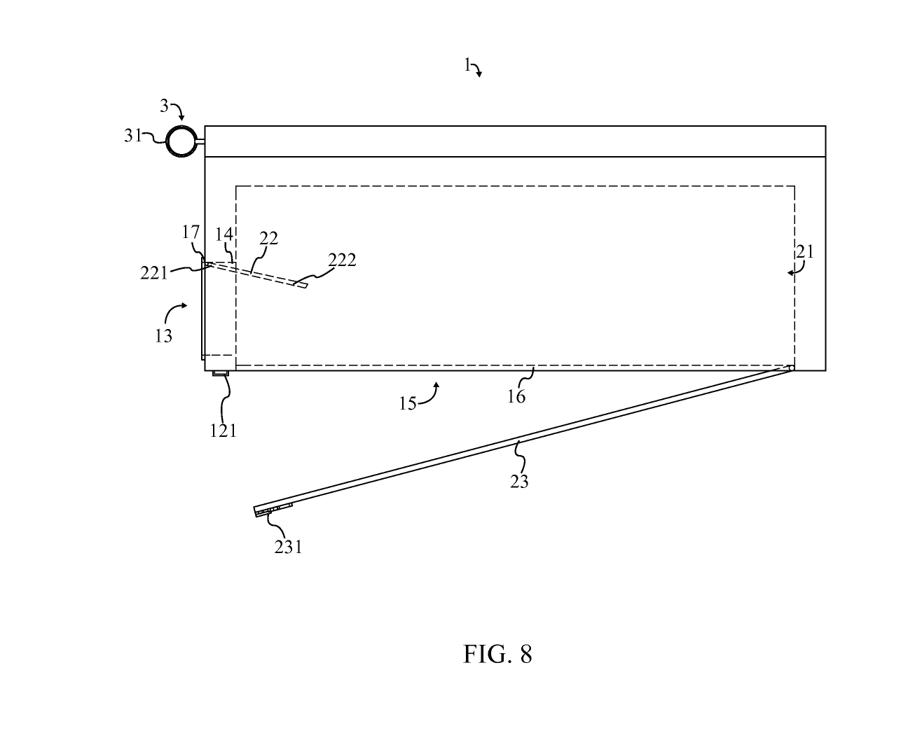

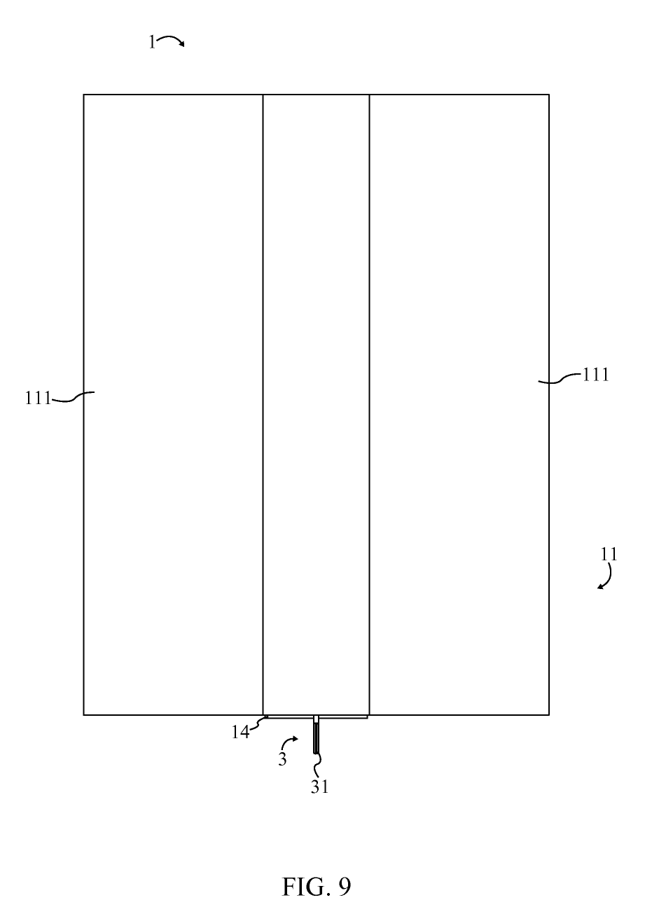

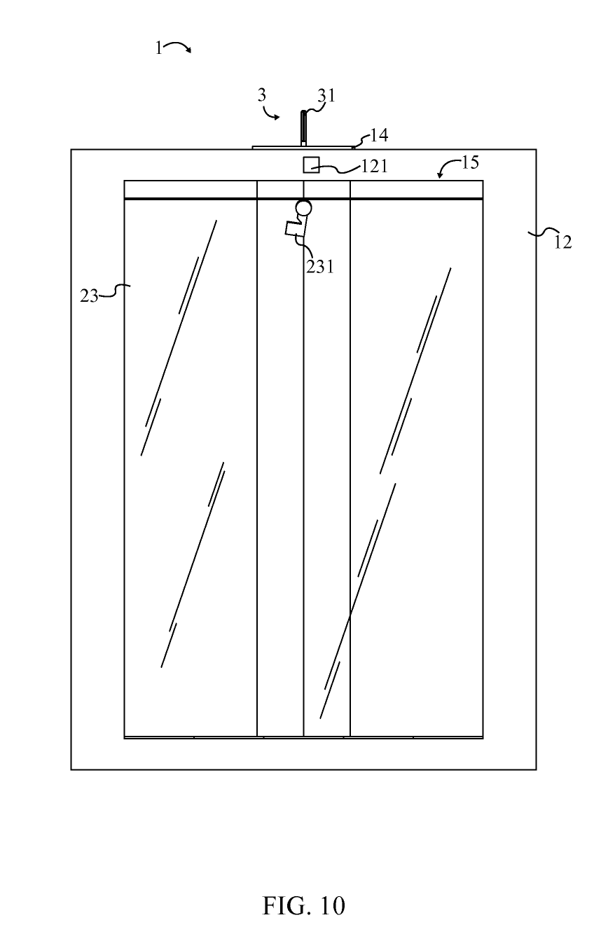

Shown in FIG. 1A-FIG. 11, the wheel chock 1 comprises a lateral surface 11, a bottom surface 12, a lateral opening 13, a lateral door frame 14, a bottom opening 15, and a bottom door frame 16. The lateral surface 11, which itself comprises at least one wheel bracing face 111 and at least one ancillary face 112, is connected around the perimeter of the bottom surface 12. The bottom surface 12 is placed on the ground, allowing the wheel bracing face 111 to be placed adjacent to a wheel, such as that of an aircraft's landing gear or a bus. In the preferred embodiment, the wheel bracing face 111 is shaped to receive a wheel. Two examples, which are not meant to be limiting, are provided; in one variation the wheel bracing face 111 could be inclined from the bottom surface 12, between zero degrees and ninety degrees. By angling the wheel bracing face 111, a wheel can roll into the wheel chock 1 without rolling over it, as might occur if the wheel bracing face 111 were flat. In another variation, the wheel bracing face 111 is concave, allowing a circular wheel to fit flush against the concave wheel bracing face 111. An illustration of the concave wheel bracing face 111 is provided in FIG. 1A, FIG. 2, and FIG. 4. The descriptions of an inclined and concave wheel bracing face 111 are provided as examples, and not meant to limit the wheel bracing face 111 which can be designed in a variety of other shapes.

In the preferred embodiment, the height of the wheel chock 1 is limited to fit the lowest common denominator. That is, the height is constrained so that the present invention is usable with a wide variety of wheels. For example, some small aircraft have wheel pants covering the wheels to improve aerodynamics. To fit such aircraft, the wheel chock 1 of the present invention would have to be limited to three inches in height, which is small enough to fit below wheel pants while still being effective enough for use with larger aircraft. Though the above example describes use with an aircraft, the present invention can be utilized in a number of situations, being capable of restraining heavy machinery, vehicles parked inside or outside, buses, trucks, and other types of transportation vehicles. In these applications, the wheel chock 1 is sized specific to the application, with the provided height being larger for trucks and buses. Ultimately, while different sizes of the present invention can be provided for different fields, the function of the present invention remains the same regardless of scaling.

The animal trap 2 comprises a chamber 21, an entrance door 22, and an access door 23, as shown in FIG. 1A-FIG. 3 and FIG. 5. The chamber 21 of the animal trap 2 is positioned within the wheel chock 1, occupying an interior section. The chamber 21 serves as a holding cell for any animals captured by the present invention. Access to the chamber 21 is provided by the entrance door 22 and the access door 23. The entrance door 22 is designed to allow one way entry into the chamber 21, such that animals may not exit the chamber 21 through the entrance door 22. The access door 23 is designed to allow a user to empty the chamber 21 of any captured animals. A benefit of the access door 23 is that the chamber 21 can be emptied by dumping the captured animals; a user is not required to physically handle the captured animals for removal or disposal. The size of the chamber 21 is ideally large enough to hold more than one rodent sized animal, such as a rat.

Potentially, poisons can be placed in the chamber 21. The use of poison would ensure that captured animals are incapable of escaping, and make the disposal of captured animals (as compared to living captured animals) easier. In addition, the presence of dead animals is likely to deter other animals from approaching the wheel chock 1. Bait, alone or in combination with poison, could also be placed within the chamber 21 in order to lure animals into the trap.

The lateral opening 13 forms a hole in the wheel chock 1, traversing through the ancillary face 112 into the chamber 21. The lateral opening 13 is delineated by the lateral door frame 14, which itself is built into the ancillary face 112. The lateral opening 13 and the lateral door frame 14 are designed to receive and secure the entrance door 22, which is positioned in the lateral opening 13. The entrance door 22 acts as a barrier to prevent animals from exiting the chamber 21 once captured.

Likewise, the bottom opening 15 traverses through the bottom surface 12 into the chamber 21, forming a second hole in the wheel chock 1. This bottom opening 15 is delineated by a bottom door frame 16, which is recessed into the bottom surface 12 of the wheel chock 1. Positioned in the bottom opening 15 is the access door 23, which can be opened by a user to release or dispose of any animals captured within the chamber 21.

The wheel chock 1 further comprises a hinge 17 which is designed to help the entrance door 22, (which is taller/longer than the lateral door frame 14), act as a one way entry. Connecting the entrance to the lateral door frame 14 is the hinge 17, which is positioned in the lateral opening 13 opposite the bottom surface 12. The positioning of the hinge 17 is further specified as being opposite the chamber 21 through the lateral opening 13, such that the hinge 17 is adjacent to the ancillary face 112 of the wheel chock 1. The hinge 17 is adjacently connected to the lateral door frame 14, at a top panel opposite the location of the bottom panel. The entrance door 22 is extended into the chamber 21 such that the size of the entrance door 22 is larger than the lateral opening 13. As a result, the entrance door 22 can only open inwards, as the lateral door frame 14 prevents the entrance door 22 from rotating outwards. This configuration allows the entrance door 22 to function as a one way portal.

The wheel chock 1 can be constructed from a variety of materials, examples of which include alloys, metals, polyurethane, and pliable plastics. The materials used to build the wheel chock 1 need to be tolerant of temperature extremes (both hot and cold), as the present invention will be used in and transported across a variety of climates. In addition to temperature tolerance, the wheel chock 1 must be durable so that it doesn't break or become damaged due to rough usage or environmental factors. The wheel chock 1 must also be strong enough to resist movement from an aircraft or other heavy vehicle without being crushed due to weight. If the wheel chock 1 is made of a metal, the metal should be corrosion resistant (either through a treatment or a protective plate covering) to protect against corrosion inducing environments. A rubber coating or gripping material can be applied the bottom surface 12 in order to prevent undesired movement of the wheel chock 1.

The entrance door 22 is pivotably connected to the hinge 17, such that the entrance door 22 rotates about an axis which is coincident with the hinge 17. The entrance door 22 comprises a rotation end 221 and a free end 222, with the rotation end 221 being positioned adjacent to the hinge 17 and the free end 222 being positioned opposite the rotation end 221 along the door. The free end 222 of the entrance door 22 is further positioned in the chamber 21. This positioning results in the entrance door's 22 rotation being limited to opening in towards the chamber 21. The entrance door 22 cannot rotate past the lateral door frame 14, since the free end 222 of the entrance door 22 hits the lateral door frame 14. This allows the entrance door 22 to act as a one way portal; animals can push the entrance door 22 open to get into the chamber 21, but the lateral door frame 14 prevents animals inside the chamber 21 from opening the entrance door 22 outwards, which would allow the trapped animals to escape. The positioning of the hinge 17 allows the entrance door 22 to automatically close due to gravitational force. Gravity acts upon the entrance door 22 to create torque, rotating the door until the free end 222 is blocked by the lateral door frame 14. Due to the relative positioning of the hinge 17, the entrance door's 22 default orientation is at an angle from the bottom surface 12.

In the preferred embodiment, the entrance door 22 further comprises a plurality of vent holes 223 which traverse through the entrance door 22. These vent holes 223 allow the scent from baits to attract animals outside of the wheel chock 1, enticing the animals to enter the chamber 21 rather than attempting to climb into a vehicle by means of the wheels. To ensure the door always closes, such as in situations when the wheel chock 1 is positioned on a steep incline, the hinge 17 can be self closing, which uses a spring mechanism to ensure the attached entrance door 22 closes, even in the absence of or in opposition to other forces (e.g. gravity).

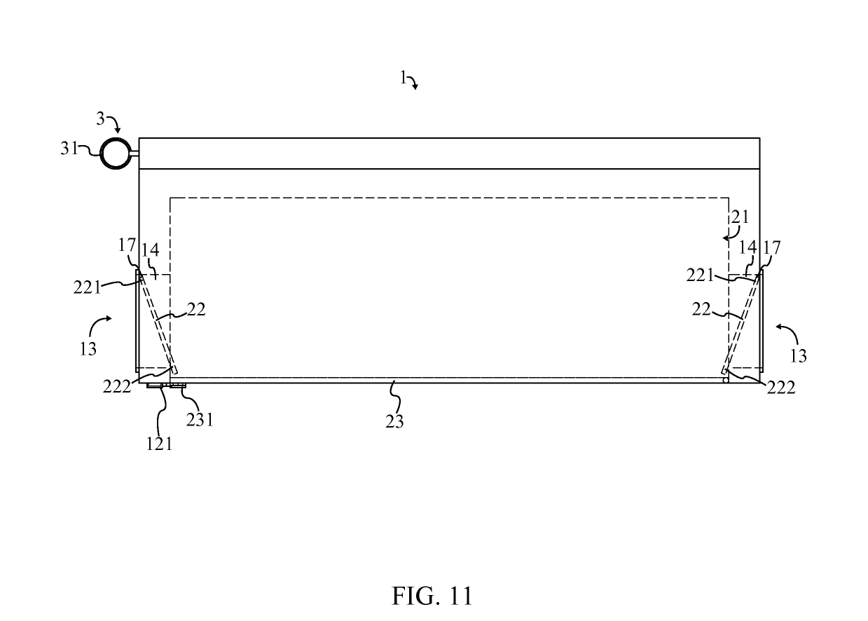

In other embodiments any additional number of ancillary faces 112 and corresponding lateral openings 13 and entrance doors 22 may be provided. In an elongated embodiment, such as shown in FIG. 1A-FIG. 10, the ancillary faces 112 may be placed opposite each other, with each ancillary face 112 providing an entrance to the chamber 21 (by means of the lateral opening 13 and entrance door 22). Similarly, the present invention may be provided with additional wheel bracing faces 111, as illustrated in FIG. 1A-FIG. 10, and FIG. 11 shows an embodiment with additional ancillary faces 112, lateral openings 13, and entrance doors 22.

The access door 23 is hingedly connected to the bottom door frame 16, the latter of which is recessed into the bottom surface 12. The recessed position of the bottom door frame 16 and connected access door 23 is important as it does not result in contact with the ground. If the bottom door frame 16 and access door 23 were not recessed, the access door 23 could be damaged by being moved across the ground, potentially resulting in scrapes, nicks, and dents to the access door 23. The access door 23 is designed to open outward, away from the bottom door frame 16, allowing any captured animals to be dumped from the chamber 21.

In the preferred embodiment, the access door 23 is held in a closed position by a latch 231 and matching latch receptacle 121. In this preferred embodiment, the access door 23 comprises a transparent section 230 and the latch 231 while the bottom surface 12 comprises the latch receptacle 121. The latch receptacle 121 is positioned on the bottom surface 12 adjacent to the bottom opening 15, while the latch 231 is positioned on the access door 23 adjacent to the latch receptacle 121. The latch 231 and latch receptacle 121 engage with each other to hold the access door 23 closed, though they can be disengaged to allow a person to open the access door 23 and empty the chamber 21. The transparent section 230 is made of a transparent material so that the wheel chock 1 can be checked for captured animals without having to actually open the access door 23. In one embodiment, the transparent section 230 encompasses the entire access door, such that the access door is transparent. In another embodiment, the transparent section 230 is a window built into the access door 23. Using a window allows the user to verify rodent and condition i.e. deceased or still alive. This would prevent user from opening the chamber and allowing the rodent to get loose or getting bitten accidentally.

A various number of solutions can be used to provide the latch 231 and latch receptacle 121; examples include, but are not limited to a pivot lock, a slide lock, and magnets positioned with opposite poles adjacent to each other. Potentially, the access door 23 can be held in place by an interference fit, also known as a friction fit, with a grip provided for opening and closing the access door 23. In this latter embodiment, the latch 231 and latch receptacle 121 can be omitted as the weight of the wheel chock 1 prevents the access door 23 from being internally opened by captured animals.

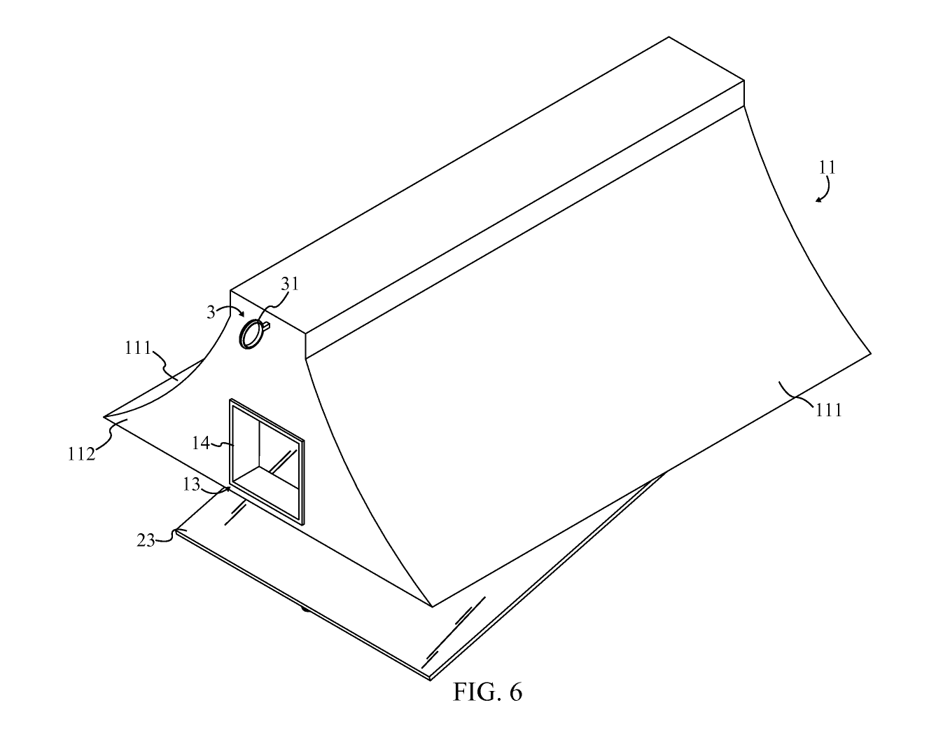

The movement of the entrance door 22 and the access door 23 is shown in FIG. 6-FIG. 10, which illustrate the entrance door 22 opened into the chamber 21 and the access door 23 opened away from the bottom surface 12. The latch 231 and latching mechanism are also shown in a disengaged state. To assist in holding, moving, and general transportation, the present invention further comprises a handle 3. This handle 3 is connected to the at least one ancillary face 112, providing a secure point from which the present invention can be carried. In the preferred embodiment, the handle 3 is a ring 31. The ring 31 shape allows a rope to be threaded through the eye of the ring 31. A user could thread a rope through the handle 3 of multiple rat trap wheel chocks, facilitating transport by allowing the entire group to be carried by a single person holding the rope. In other embodiments, different style handles 3 could be used, for example a u-shaped handle, I-loop, or a knob handle. The handle 3 should be molded into the wheel chock 1 during the manufacturing process to ensure a secure and tight fit that won't come loose when the wheel chock 1 is being carried by the handle 3. The handle 3 could also be installed by drilling a hole into the wheel chock 1 and fastening the handle 3 through the use of a lock nut and washers, with the lock nut and washers preferably being metal.

Although the invention has been explained in relation to its preferred embodiment, it is to be understood that many other possible modifications and variations can be made without departing from the spirit and scope of the invention as hereinafter claimed.

What is claimed is:

1. A rat trap wheel chock comprises:
a wheel chock;
an animal trap;
the wheel chock comprises a lateral surface, a bottom surface, a lateral opening, a lateral door frame, a bottom opening, and a bottom door frame;
the lateral surface comprises at least one wheel bracing face and at least one ancillary face;
the animal trap comprises a chamber, an entrance door, and an access door;
the chamber being positioned within the wheel chock;
the bottom opening traversing through the bottom surface into the chamber;
the lateral opening traversing through the ancillary face into the chamber;
the entrance door being positioned in the lateral opening;
the access door being positioned in the bottom opening;
the lateral opening being delineated by the lateral door frame; and
the bottom opening being delineated by the bottom door frame.

2. The rat trap wheel chock as claimed in claim 1 further comprises:
the wheel chock further comprises a hinge;
the entrance door comprises a rotation end and a free end;
the entrance door being longer than the lateral door frame, wherein the entrance door cannot rotate past the lateral door frame;
the hinge being positioned in the lateral opening opposite the bottom surface;
the hinge being positioned opposite the chamber through the lateral opening;
the hinge being adjacently connected to the lateral door frame;
the entrance door being pivotably connected to the hinge;
the rotation end being positioned adjacent to the hinge;
the free end being positioned opposite the rotation end along the door; and
the free end being positioned in the chamber.

3. The rat trap wheel chock as claimed in claim 2 further comprises:
the entrance door further comprises a plurality of vent holes; and
the plurality of vent holes traversing through the entrance door.

4. The rat trap wheel chock as claimed in claim 2 further comprises:
the hinge being self closing.

5. The rat trap wheel chock as claimed in claim 1 further comprises:
the bottom door frame being recessed into the bottom surface; and
the access door being hingedly connected to the bottom door frame.

6. The rat trap wheel chock as claimed in claim 5 further comprises:
the access door comprises a transparent section and a latch;
the bottom surface comprises a latch receptacle;
the latch receptacle being positioned adjacent to the bottom opening;
the latch being positioned on the access door adjacent to the latch receptacle; and
the latch being engaged with the latch receptacle.

7. The rat trap wheel chock as claimed in claim 1 further comprises:
the wheel bracing face being inclined from the bottom surface.

8. The rat trap wheel chock as claimed in claim 1 further comprises:
the wheel bracing face being concave.

9. The rat trap wheel chock as claimed in claim 1 further comprises:
a handle;
the handle being connected to the at least one ancillary face; and
the handle being a ring.

10. A rat trap wheel chock comprises:
a wheel chock;
an animal trap;
the wheel chock comprises a lateral surface, a bottom surface, a lateral opening, a lateral door frame, a bottom opening, a bottom door frame, and a hinge;
the lateral surface comprises at least one wheel bracing face and at least one ancillary face;
the animal trap comprises a chamber, an entrance door, and an access door;
the chamber being positioned within the wheel chock;
the bottom opening traversing through the bottom surface into the chamber;
the lateral opening traversing through the ancillary face into the chamber;
the hinge being positioned in the lateral opening opposite the bottom surface;
the entrance door being positioned in the lateral opening;
the entrance door being pivotably connected to the hinge;
the access door being positioned in the bottom opening;
the lateral opening being delineated by the lateral door frame; and
the bottom opening being delineated by the bottom door frame.

11. The rat trap wheel chock as claimed in claim 10 further comprises:
the entrance door comprises a rotation end and a free end;
the entrance door being longer than the lateral door frame, wherein the entrance door cannot rotate past the lateral door frame;
the hinge being positioned opposite the chamber through the lateral opening;
the hinge being adjacently connected to the lateral door frame;
the rotation end being positioned adjacent to the hinge;
the free end being positioned opposite the rotation end along the door;
the free end being positioned in the chamber;
the entrance door further comprises a plurality of vent holes; and
the plurality of vent holes traversing through the entrance door.

12. The rat trap wheel chock as claimed in claim 10 further comprises:
the hinge being self closing;

13. The rat trap wheel chock as claimed in claim 10 further comprises:
the bottom door frame being recessed into the bottom surface;
the access door being hingedly connected to the bottom door frame;
the access door comprises a transparent section and a latch;
the bottom surface comprises a latch receptacle;
the latch receptacle being positioned adjacent to the bottom opening;
the latch being positioned on the access door adjacent to the latch receptacle; and
the latch being engaged with the latch receptacle.

14. The rat trap wheel chock as claimed in claim 10 further comprises:
the wheel bracing face being inclined from the bottom surface.

15. The rat trap wheel chock as claimed in claim 10 further comprises:
the wheel bracing face being concave.

16. The rat trap wheel chock as claimed in claim 10 further comprises:
a handle;
the handle being connected to the at least one ancillary face; and
the handle being a ring.

17. A rat trap wheel chock comprises:
a wheel chock;
an animal trap;
the wheel chock comprises a lateral surface, a bottom surface, a lateral opening, a lateral door frame, a bottom opening, a bottom door frame, and a hinge;
the lateral surface comprises at least one wheel bracing face and at least one ancillary face;
the wheel bracing face being concave;
the animal trap comprises a chamber, an entrance door, and an access door;
the chamber being positioned within the wheel chock;
the bottom opening traversing through the bottom surface into the chamber;
the lateral opening traversing through the ancillary face into the chamber;
the hinge being positioned in the lateral opening opposite the bottom surface;
the hinge being positioned opposite the chamber through the lateral opening;
the hinge being adjacently connected to the lateral door frame;
the entrance door being positioned in the lateral opening;
the entrance door being pivotably connected to the hinge;
the entrance door being longer than the lateral door frame, wherein the entrance door cannot rotate past the lateral door frame;
the entrance door being longer than the frame;
the access door being positioned in the bottom opening;
the access door being hingedly connected to the bottom door frame;
the lateral opening being delineated by the lateral door frame; and
the bottom opening being delineated by the bottom door frame.

18. The rat trap wheel chock as claimed in claim 17 further comprises:
the entrance door comprises a rotation end and a free end;
the rotation end being positioned adjacent to the hinge;
the free end being positioned opposite the rotation end along the door;
the free end being positioned in the chamber;
the entrance door further comprises a plurality of vent holes;
the plurality of vent holes traversing through the entrance door; and
the hinge being self closing.

19. The rat trap wheel chock as claimed in claim 17 further comprises:
the bottom door frame being recessed into the bottom surface;
the access door comprises a transparent section and a latch;
the bottom surface comprises a latch receptacle;
the latch receptacle being positioned adjacent to the bottom opening;
the latch being positioned on the access door adjacent to the latch receptacle; and
the latch being engaged with the latch receptacle.

20. The rat trap wheel chock as claimed in claim 17 further comprises:
a handle;
the handle being connected to the at least one ancillary face; and
the handle being a ring.
